(19) United States
(12) Patent Application Publication
(10) Pub. No.: US 2002/0118417 A1
(43) Pub. Date: Aug. 29, 2002

(54) Flexible optical add/drop architecture

(76) Inventors: Richard A. Barry, Brookline, MA (US); Murat Azizoglu, Concord, MA (US)

Correspondence Address: LAHIVE & COCKFIELD, 28 STATE STREET, BOSTON, MA, 02109, US

(21) Appl. No.: 09/777,556

(22) Filed: Feb. 5, 2001

(51) Int. Cl. H04J 14/02; G02B 6/28

(52) U.S. Cl. 359/127; 385/24

(57) ABSTRACT

In an optical communications network, an optical add/drop node that is flexible to support changing traffic demands, and also induces little loss to the signal. The optical add/drop node of the present invention utilizes a filter that is capable of adding and dropping wavelengths across different bands in a multiplexed signal. The Optical Add/Drop Node of the invention is flexible to adjust with changing traffic demands by reserving bandwidth for future use. The present invention provides immediate scalability to the optical network without requiring reconfiguration of the network architecture. In addition to providing flexibility for future expansion, the invention also reduces loss to the signal passing through the network. This is accomplished by reducing the number of connection points in the filter relative to an alternative flexible add/drop solution. (P50)

### TECHNICAL FIELD

The present invention relates to optical add/drop architecture for adding and dropping wavelength signals in an optical communications network employing wavelength division multiplexing. More particularly, the present invention relates to a flexible optical add/drop node in an optical communications network.

### BACKGROUND OF THE INVENTION

In an optical network, information is transmitted in the form of light pulses corresponding to a particular optical carrier wavelength. To increase transmission capacity, networks frequently employ Wavelength Division Multiplexing (WDM) technology. WDM increases fiber capacity by transmitting optical information signals over a plurality of channels on a single fiber optic strand. Each channel in the fiber occupies a distinct wavelength of light. Dense Wavelength Division Multiplexing (DWDM) delivers the technology to divide each fiber strand into more than 80 parallel optical wavelength channels, further increasing network capacity. The channels carried by the fiber strand are typically organized into discrete bands, where each band is defined by a fixed number of contiguous, closely spaced wavelengths.

Add/drop functionality is an important feature of WDM or DWDM-based optical networking transport products. At certain locations in the network, an add/drop node inserts (i.e. “adds”) supplementary optical signals from the node into a multiplexed carrier signal. The add/drop node also removes (i.e. “drops”) individual optical signals from the multiplexed carrier signal so that traffic destined for the node may be extracted from the signal. In an all-optical network, the optical path is transparent (i.e. no electronic domain processing) except at the add/drop nodes, where the optical path is transparent to all wavelength signals except those being accessed by the node. Wavelengths that are not accessed by a node pass through without being converted into the electrical domain. Added wavelength signals are multiplexed into a multiplexed carrier signal without affecting or disrupting the “through” wavelength signals (i.e. the signals that pass through the node), and wavelength signals to be dropped are demultiplexed from the multiplexed carrier signal without affecting or disrupting the “through” wavelength signals.

In the current state of the art, an entire band of wavelengths is added/dropped at a node. While a band drop filter is simple to implement, the band-drop filter is inefficient and difficult to scale to changing traffic demands of the node. Band drop filters are useful at Optical Add/Drop Nodes with a large traffic demand from a terminal node, since the band drop filter accesses a large number of wavelength signals at a time, but are ineffective for other traffic needs.

A practical alternative for nodes with widely varying traffic demands is to use cascaded add/drop filters in a modular fashion. An appropriate combination of fixed add/drop filters is selected and implemented at an OADN in order to satisfy the traffic demand. Each filter is designed to access one specific wavelength of the signal. While this arrangement minimizes the need for network preplanning, since the node can add/drop individual wavelengths without the structural inter-wavelength restrictions found in band drop filters, the modular add/drop filters are cascaded on separate cards, leading to a high loss in the signal power (primarily due to an increased number of optical connector elements). While it is easier to adjust to traffic demands, the high loss that is induced on the signal poses a significant disadvantage in the optical network, increasing the need for costly optical amplification.

### SUMMARY OF THE INVENTION

The present invention provides an Optical Add/Drop Node that is flexible to support changing traffic demands, yet also induces little optical power loss to the signal. The Add/Drop node of the present invention is capable of managing the frequently unpredictable demand of data traffic to a node and has the capacity and flexibility to meet the unpredictable and constantly changing data needs of customers.

The Optical Add/Drop Node of the illustrative embodiment of the present invention utilizes a filter that is capable of adding and dropping wavelengths across different bands in the multiplexed signal. The Optical Add/Drop Node adjusts with changing traffic demands by reserving bandwidth for future use. The present invention provides immediate scalability without requiring reconfiguration of the network architecture. In addition to providing flexibility for future expansion, the invention also reduces loss to the signal passing through the network by reducing the number of connection points in the filter.

The invention provides a network architecture that is scalable, flexible, cost-effective, and capable of supporting the anticipated growth in demand for high-speed data communications services.

According to an illustrative embodiment, the present invention provides a method of adding and dropping a fixed set of wavelengths from a multi-wavelength optical signal. This method comprises determining the fixed set of wavelengths to be add/dropped at an intermediate node in the network, and deploying a filter to add/drop the fixed set while passively forwarding all wavelengths in the optical signal that do not comprise the fixed set. The fixed set includes wavelengths from different bands in the signal.

According to an alternate embodiment, the invention provides an optical add/drop node in an optical communications network. The node includes an optical add/drop card containing a fixed add/drop filter. The fixed add/drop filter is configured to add and drop a fixed set of wavelengths at the node while passively forwarding wavelengths through the node that do not comprise the fixed set. The fixed set includes wavelengths from different bands in the signal.

According to another embodiment, a fixed set of wavelengths that is accessed at a node of the present invention is comprised of one wavelength from each band in a multiplexed signal.

According to yet another embodiment, a fixed set of wavelengths that is accessed at a node of the present invention comprises two wavelengths from two different bands in an optical network.

### BRIEF DESCRIPTION OF THE FIGURES

FIG. 1 illustrates a schematic view of a network suitable for implementing the add/drop node of an illustrative embodiment of the present invention.

FIG. 2 illustrates a channel plan for a network suitable for implementing the add/drop node of an illustrative embodiment of the present invention.

FIG. 3 illustrates a cascaded add/drop node of the prior art.

FIG. 4 illustrates a band-drop filter node of the prior art.

FIG. 5a illustrates a flexible optical node of an illustrative embodiment of the present invention.

FIG. 5b illustrates an alternate flexible add/drop node of an illustrative embodiment of the present invention.

FIG. 6 is a schematic view of an application of an illustrative embodiment of the present invention in a network.

FIG. 7 is a schematic view of an optical add/drop node of an illustrative embodiment of the present invention.

FIG. 8 is a schematic view of an alternate embodiment of an add/drop node of and illustrative embodiment of the present invention.

### DETAILED DESCRIPTION OF THE INVENTION

The present invention provides flexible add/drop architecture in an optical networking transport system. The add/drop architecture is capable of adapting and scaling to changing traffic patterns and demands while providing efficient transmission of the signal without significant losses. The add/drop architecture drops wavelengths across a plurality of bands in a multiplexed signal. While the illustrative embodiment of the invention depicts a unidirectional, long haul transport network, it is understood that the add/drop architecture of the present invention may be utilized in other optical transmission systems as well. The present invention may be configurable for access, metro core, long-haul and other transport applications.

FIG. 1 illustrates an optical network 20 suitable for implementing an illustrative embodiment of the present invention. The network 20 of FIG. 1 is designed to transmit over a long distance of up to several hundred kilometers without electrical regeneration, maintaining signals in the optical domain throughout transmission. The network 20 is comprised of two terminal nodes 21, 22 and a plurality of intermediate nodes 23, 24 connected by an optical fiber 25 for transmitting information in the form of light pulses through the network. In a network, a node is a processing location at which transmitting or receiving equipment is connected to the network. The optical fiber carries a plurality of channels, and each channel carries an information signal modulated onto a specific wavelength of light. The wavelength channels are organized into bands, where each band consists of a fixed number of contiguous, closely spaced wavelengths.

A typical channel plan for an optical network having eight bands (A, B, C, D, E, F, G, H) is illustrated in FIG. 2. Each band consists of four or six consecutive wavelengths spaced at intervals of about 0.8 nanometers (100 GHz). Some of these bands are designated as add/drop bands, while others are designated as express bands. An add/drop band contains wavelengths that can be accessed at an intermediate node in the network. Conversely, an express band can be accessed only at terminal nodes. Any number of bands may be designated as express bands, depending on the network design. In the channel plan illustrated in FIG. 2, bands A, B, C, and D are add/drop bands, while bands E, F, G, and H are express bands.

Intermediate nodes in an optical network are add/drop nodes where information is either extracted from the network (i.e. “dropped”) or inserted (i.e. “added”) into the network. Each intermediate node adds and/or drops information associated with specific wavelengths and passively forwards remaining wavelengths that do not need to be accessed by the intermediate node. “Express” wavelengths carry information from one terminal node to another and pass unaffected through all intermediate nodes in the network. At a terminal node, the entire signal is dropped and all information carried in the signal is accessed.

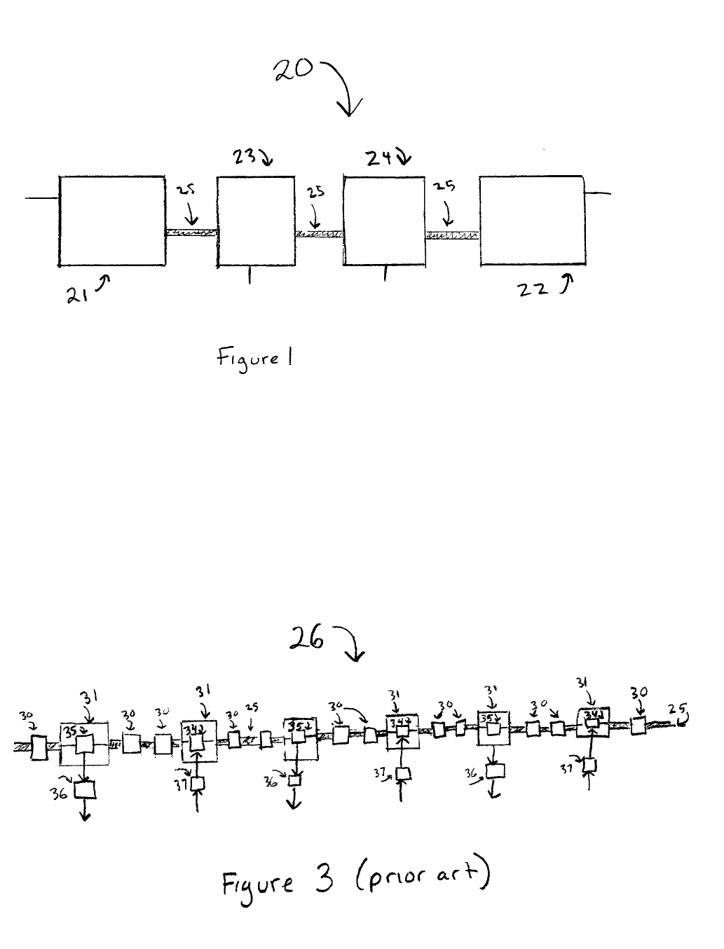

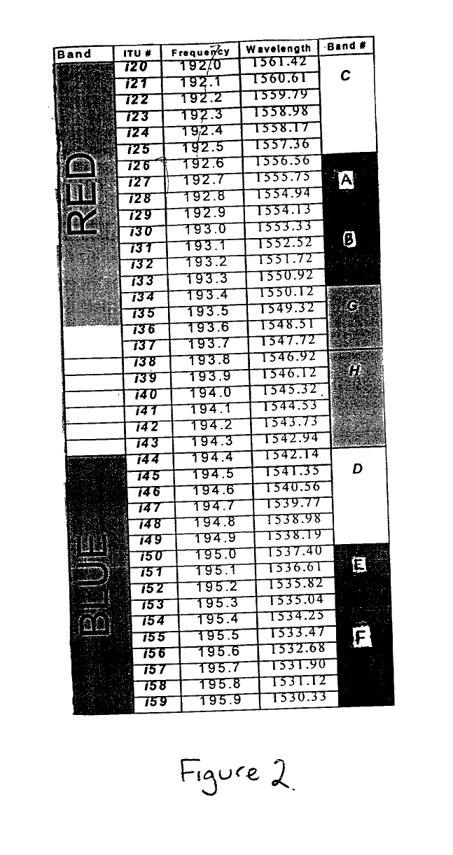

FIG. 3 depicts an add/drop node 26 of the prior art having cascaded filters to satisfy traffic demand. At each intermediate add/drop node of the network, single wavelength add/drop filter cassettes (SWACs) 31 are cascaded in separate cards or chassis. Each filter cassette corresponds to a particular wavelength in the signal, and contains two end connectors 30. As the multiplexed signal passes through each filter cassette, the particular wavelength channel corresponding to the filter is extracted from the signal and converted to the electrical domain. Conversely, information to be added is converted from the electrical domain to an optical signal of a wavelength corresponding to a particular filter cassette, and inserted into the multiplexed signal. The arrangement illustrated in FIG. 3 incurs a high loss in the network, as each connector 30 in the node generates a loss in the signal power. In addition to a loss in the signal power for transmission through each filter, this translates into a significant optical power loss when dropping a wavelength and when adding a wavelength. For example, for current implementations, each connector generates a loss of 0.25 dB in addition to a 0.5 dB loss through each filter. This translates into a loss of 1dB when dropping a wavelength and 1 dB for adding a wavelength. The total loss to the signal at each node of the embodiment illustrated in FIG. 3 is 2 dB times the number of wavelengths that are accessed at each node, as each wavelength to be accessed has an individual cascaded filter cassette. In addition to incurring a high loss in the signal, the arrangement illustrated in FIG. 3 is complicated. Each wavelength that is accessed by the node requires two connectors 30, a multiplexer 34, a demultiplexer 35, a transmitter 36 for converting an electrical signal to an optical signal of the respective wavelength, and a receiver 37 for converting the optical signal corresponding to the respective wavelength to an electrical signal.

Amplifiers may be used to compensate for the loss at nodes comprising cascaded SWACs 31. However, another problem with such nodes is that the spontaneous emission noise from optical amplifiers that are required in each node tends to accumulate and limit the transmission distance.

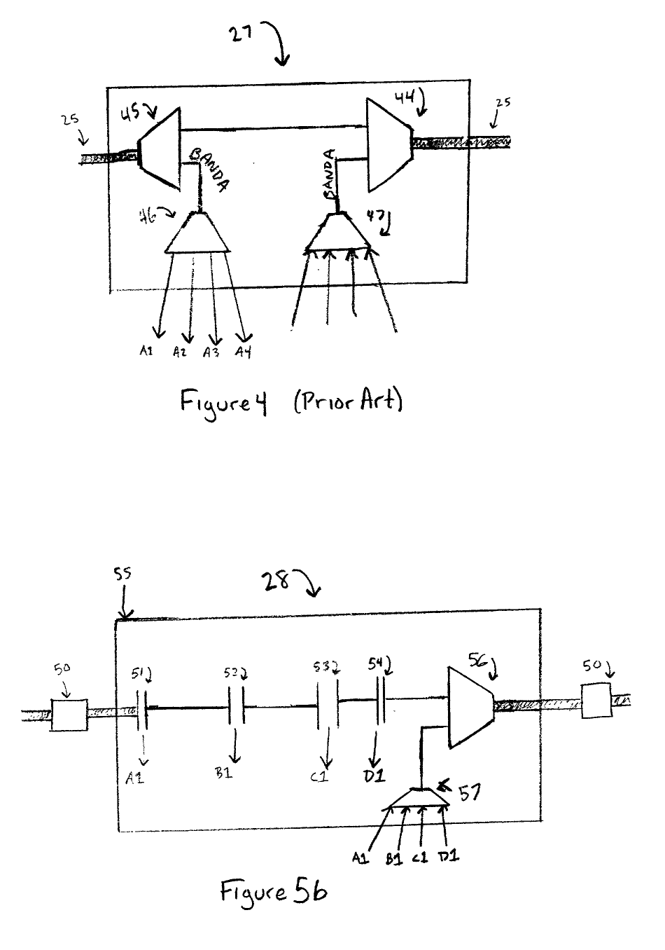

FIG. 4 illustrates a prior art filter 27 where an entire band of wavelengths is added/dropped at each node. In this arrangement, wide band optical filters are used to isolate a band of wavelengths in the signal and drop the isolated band. Wlhen dropping wavelengths, a band-drop filter is used to divert an entire band of wavelengths from the multiplexed signal. Demultiplexer 45 extracts all wavelengths A1, A2, A3 and A4 in Band A of a channel plan for the network. Optical filter 46, which may comprise a plurality of individual filters, then separates Band A into individual wavelength signals to be converted to the electrical domain. Channel filter 47 combines wavelengths A1, A2, A3, A4 and passes the combined signal to multiplexer 44, where the combined signal is inserted into the multiplexed through signal. The arrangement illustrated in FIG. 4 also poses problems in the network, as the node is inflexible to varying traffic demands. A band-drop filter 27 accesses information associated with all wavelengths in a specific band. After a wavelength is dropped from a multiplexed signal, the information carried on the wavelength must be regenerated if that wavelength was not intended to be terminated at that node.

In the illustrative embodiment of the present invention, a flexible add/drop filter adjusts to changing traffic demands at each node, while reducing the amount of loss to the signal at each node. In the illustrative embodiment of the present invention, a fixed set of wavelengths, comprised of wavelengths from different bands of the multiplexed signal, is added/dropped at an intermediate node in the optical network. FIGS. 5a and 5b show illustrative embodiments of the present invention. In the embodiment illustrated in FIGS. 5a and 5b, the flexible add/drop node 28 of the present invention comprises a plurality of thin-film filters 51, 52, 53, 54 cascaded on a single optical add/drop card 55 or chassis. Each intermediate node contains a single optical add/drop card 55 capable of add/dropping a plurality of wavelengths. The optical add/drop card 55 is comprised of a plurality of optical thin-film filters corresponding to specific wavelengths. The thin-film filter is a passive device containing two parallel mirrors that are partially reflective and partially transparent. The index of refraction of the medium, and the spacing between the parallel mirrors determine which wavelengths transmit through the filter unaffected and which wavelengths are reflected and accessed by the node.

The present invention requires only two end connectors 50 for the entire node, allowing the signal to be efficiently conveyed through the node, without significant loss to the signal. The filter is capable of dropping wavelengths across a plurality of bands in the signal. In this case, the fixed set of wavelengths includes wavelengths from different bands that are accessed at each intermediate node. The first thin-film filter 51 corresponds to wavelength A1 from Band A in the channel plan for the network. The second thin-film filter 52 corresponds to wavelength B1 from Band B, the third thin-film filter 53 corresponds to wavelength C1 from Band C, and filter 54 corresponds to wavelength D1 of Band D.

When accessing wavelengths in the signal, a node extracts the fixed set of wavelengths from the multiplexed signal. The dropped wavelength signals are then converted into electrical signals at the node, so that the information carried in the form of wavelengths of light may be accessed.

FIG. 5b illustrates an alternate intermediate node for both adding and dropping optical signals in the network. The adding of optical signals is accomplished in a complementary manner as that previously described for dropping optical signals. Optical transmitters in position at the node generate optical signals of particular wavelengths carrying information to be added to the multi-wavelength signal. An optical combiner 57 combines optical signals from a plurality of inputs into a single output comprising the fixed set of wavelengths. The signal comprised of the fixed set of wavelengths is then inserted into the multiplexed through signal by multiplexer 56.

While the illustrated arrangement may be less efficient in utilizing available bandwidth, since the fixed set of wavelengths is always dropped even if a single wavelength worth of traffic is present at the node, the illustrated arrangement allows flexibility for growth. The illustrated configuration reserves bandwidth for future add/drop traffic at a node. In this manner, the add/drop architecture for a particular band of wavelengths does not need to be in place from day one of the network's deployment. The illustrated add/drop node configuration provides immediate scalability to the network without necessitating deployment of new filters.

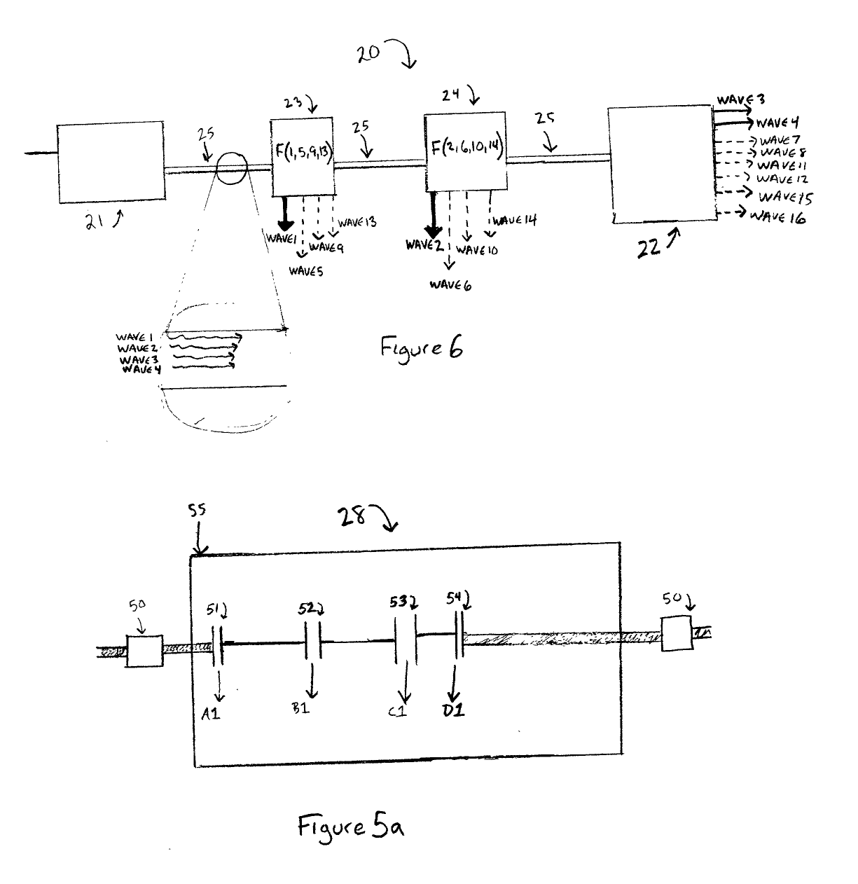

An application of an illustrative embodiment of the present invention is shown in FIG. 6. FIG. 6 illustrates a four node unidirectional network similar to the network of FIG. 1, in which nodes 21 and 22 are terminal nodes, and nodes 23 and 24 are intermediate add/drop nodes. In the illustrated network, there is one unit of traffic between nodes 21 and 23, one unit of traffic between nodes 21 and 24, and two units of express traffic between nodes 21 and 22. While FIG. 6 illustrates add/drop architecture for extracting wavelengths at intermediate nodes in a network, it is understood that the illustrated architecture can also be used to add traffic to the network in a complementary manner. Wavelengthl is assigned to carry information between node 21 and node 23, wavelength2 between node 21 and node 24, and wavelength3 and wavelength4 to the connection between node 21 and node 22. In the multiplexed signal, Band 1 is comprised of adjacent wavelengths wavelengthl, wavelength2, wavelength3, and wavelength4, each having a distinct wavelength. Band 2, which is not currently employed in the network, comprises adjacent wavelengths wavelengths, wavelength6, wavelength7, and wavelengths. Band 3 and Band 4, also not in use, comprise adjacent wavelengths wavelength9, wavelength10, wavelength11 and wavelength12, and wavelengthl3, wavelengthl4, wavelengthl5 and wavelengthl6, respectively. According to the present invention, the add/drop filter deployed at node 23 corresponds to wavelengthl, wavelengths, wavelength9 and wavelengthl3. This filter is designated F(1,5,9,13). The filter at node 24 accesses wavelength2, wavelength6, wavelength10, and wavelengthl4, and is designated F(2,6,10,14). While only Band 1 (wavelengths 14) is utilized by the network at the present time, the add/drop architecture illustrated in FIG. 6 simply and easily scales to increasing traffic demand. For example, the supported traffic rates can be doubled through the nodes 21-23 connection, the nodes 21-24 connection, and the nodes 21-22 connection by deploying a new band of wavelengths, such as Band 2, comprises of wavelengths 5, 6, 7 and 8. With deployment of Band 2, wavelengths can carry traffic along the 21-23 connection, wavelength6 can carry traffic along the 21-24 connection, and wavelength7 and wavelengths can carry express traffic through the 21-22 connection. As the add/drop architecture for carrying information on Band 2 is in place beforehand, the increase in the amount of information carried by the network occurs without necessitating modification of the network or disruption of existing service.

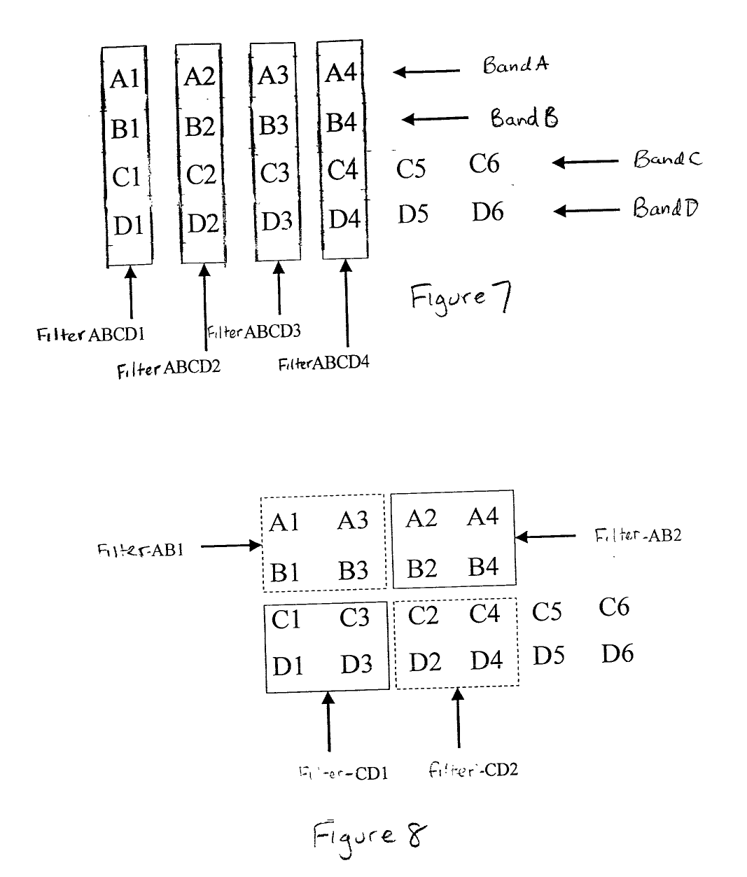

The present invention is flexible regarding the selection of wavelengths to be add/dropped at each node. FIGS. 7 and 8 illustrate the various approaches to partitioning the bands into filter components. The first filter embodiment, shown in FIG. 7, in which one wavelength from each band (Band A, Band B, Band C and Band D) is accessed by a node, is shown as Filter ABCD 1. The first filter embodiment corresponds to one wavelength per band in the signal. As illustrated, Filter ABCD1 corresponds to the first wavelength in each band, Filter ABCD2 corresponds to the second wavelength in each band, etc. However, the filter is not limited to the depicted embodiment, and any combination of wavelengths may be used. For example, a filter may correspond to the first wavelength in a first band, a third wavelength in a second band, a fourth wavelength in a third band, and a first wavelength in a fourth band, etc.

In an alternate embodiment illustrated in FIG. 8, two wavelengths, Al and A3, from a first band, and two wavelengths, B1 and B3 from a second band are add/dropped by Filter-AB1. Filter-AB2 corresponds to wavelengths A2 and A4 from Band A, and wavelengths B2 and B4 from Band B. Filter-CD1 corresponds to wavelengths C1, C3, D1 and D3 from Band C and Band D, respectively, and Filter-CD2 corresponds to wavelengths C2, C4, D2 and D4 from Band C and Band D, respectively. Again, the present invention is not limited to two specific wavelengths from each band, but rather, may correspond to any two wavelengths from different bands in a channel plan. The present invention is not limited to the configurations illustrated in FIGS. 7 and 8. Alternate embodiments include an optical add/drop card corresponding to a variety of different combinations of wavelengths from different bands in a channel plan for a network.

There are significant advantages to this type of configuration of an add/drop node. The scalable architecture enables a network to grow incrementally as customer requirements and business opportunities dictate, eliminating the need to overbuild ahead of demand. The network easily increases its capacity without interrupting service, by simply deploying a new band of wavelengths. The add/drop architecture is in position beforehand to support this growth. An optical network utilizing the add/drop architecture of the present invention enables maximum utilization of resources at the lowest cost and provides the scalability required to meet the ever-changing demand for high-speed services. In addition to providing flexibility to a network, the add/drop architecture of the present invention provides efficient transmission of a signal by reducing loss and noise at intermediate nodes. Thus, the present invention provides efficient routing of wavelength based traffic.

While the present invention has been described with reference to illustrative embodiments, it will be recognized by one of ordinary skill in the art that modifications and alterations may be made without departing from the spirit and scope of the invention. Accordingly, the description and drawings are intended to be exemplary and are for the purpose of teaching those skilled in the art the best mode for carrying out the invention. Details of the structure may vary substantially without departing from the spirit and scope of the invention, as determined by reference to the appended claims.

1. An optical node for dropping wavelengths from a multi-wavelength optical signal in an optical communications network, wherein said network comprises a plurality of nodes connected by an optical transmission medium carrying a plurality of wavelengths divided into discrete bands, wherein each band constitutes a group of contiguous wavelengths, said node comprising:
an optical drop unit containing a fixed drop filter, wherein said filter drops a fixed set of wavelengths at the node, wherein the fixed set includes wavelengths from different bands, while forwarding wavelengths that do not comprise the fixed set through the node.

2. The optical node according to claim 1, wherein the fixed set of wavelengths is predetermined prior to installation of the filter in the network.

3. The optical node of claim 2, wherein the fixed set of wavelengths is independent of a level of traffic at the node.

4. The optical node of claim 2, wherein the fixed set initially includes wavelengths that do not carry information, in order to reserve the wavelengths that do not carry information for future growth of the network.

5. The optical node of claim 4, wherein the node includes:
a plurality of thin-film filters for removing the fixed set of wavelengths from the network; and
a receiver for converting the fixed set of wavelengths to electrical signals.

6. The node of claim 1, wherein the fixed set comprises one wavelength from each band in the network.

7. The node of claim 1, wherein the fixed set comprises two wavelengths from a first band, and two wavelengths from a second band.

8. The node of claim 1, wherein the fixed set comprises a first wavelength from a first band, and a plurality of wavelengths from a second band.

9. The node of claim 1, wherein the fixed set comprises multiple wavelengths from a plurality of bands.

10. A fixed filter for an optical node in an optical communications network, said network comprising a transmission medium carrying wavelengths divided into discrete bands, wherein each band is defined by a group of contiguous wavelengths, said filter comprising:
a plurality of optical filters arranged in series on a single optical drop card, wherein each thin-film filter is designed to drop a predetermined wavelength from a multi-wavelength optical signal and forward all wavelengths other than said predetermined wavelength.

11. The fixed filter of claim 10, wherein the plurality of optical filters comprises a plurality of optical thin-film filters.

12. The fixed filter according to claim 10, wherein a first optical filter drops a first wavelength from a first band and a second optical filter drops a second wavelength from a second band.

13. The fixed filter according to claim 10, wherein a first optical filter drops a first wavelength from a first band, a second optical filter drops a second wavelength from said first band, a third optical filter drops a third wavelength from a second band, and a fourth optical filter drops a fourth wavelength from said second band.

14. The fixed filter according to claim 10, wherein the fixed drop filter drops a fixed set of wavelengths from a plurality of bands in the multi-wavelength optical signal.

15. A method of dropping wavelengths from a multi-wavelength optical signal in an optical communications network, said network comprising a plurality of nodes connected by an optical transmission medium carrying a plurality of wavelengths divided into discrete bands, wherein each band constitutes a group of contiguous wavelengths, said method comprising:
determining a fixed set of wavelengths to be dropped at an intermediate node in the network, wherein the fixed set includes wavelengths from a plurality bands in the multi-wavelength optical signal;
deploying a filter to drop the fixed set; and
forwarding wavelengths in the optical signal that do not comprise the fixed set.

16. The method of claim 15, wherein the step of determining the fixed set includes partitioning each band into a first subset of wavelengths to be dropped at a particular node and a second subset of wavelengths to pass through the node unaffected.

17. The method of claim 16, wherein the step of determining the fixed set further includes selecting individual filter components that correspond to each wavelength in the fixed set.

18. The method of claim 16, wherein the step of partitioning includes selecting one wavelength from each band in the multi-wavelength optical signal to be included in the first subset.

19. The method of claim 16, wherein the step of partitioning includes selecting two wavelengths from a first band and two wavelengths from a second band to be included in the first subset.

20. The method of claim 16, wherein the step of partitioning includes selecting one wavelength from a first band, and a plurality of wavelengths from a second band to be included in the first subset.

21. The method of claim 16, wherein the step of partitioning includes selecting multiple wavelengths from a plurality of bands to be included in the first subset.

22. An optical node for adding wavelengths to a multi-wavelength optical signal in an optical communications network, wherein said network comprises a plurality of nodes connected by an optical transmission medium carrying a plurality of wavelengths divided into discrete bands, wherein each band constitutes a group of contiguous wavelengths, said node comprising:
an optical add unit containing a fixed filter, wherein said filter adds a fixed set of wavelengths to the multi-wavelength optical signal at the node, wherein the fixed set includes wavelengths from different bands.

23. The optical node according to claim 22, wherein the fixed set of wavelengths is predetermined prior to installation of the filter in the network.

24. The optical node of claim 23, wherein the fixed set of wavelengths is independent of a level of traffic at the node.

25. The optical node of claim 23, wherein the fixed set initially includes wavelengths that do not carry information, in order to reserve the wavelengths that do not carry information for future growth of the network.

26. The node of claim 22, wherein the fixed set comprises one wavelength from each band in the network.

27. The node of claim 22, wherein the fixed set comprises two wavelengths from a first band, and two wavelengths from a second band.

28. The node of claim 22, wherein the fixed set comprises a first wavelength from a first band, and a plurality of wavelengths from a second band.

29. The node of claim 22, wherein the fixed set comprises multiple wavelengths from a plurality of bands.

30. An optical add/drop node for adding and dropping wavelengths from a multiwavelength optical signal in an optical communications network, wherein said network comprises a plurality of nodes connected by an optical transmission medium carrying a plurality of wavelengths divided into discrete bands, wherein each band constitutes a group of contiguous wavelengths, said node comprising:
an optical add/drop unit containing a fixed add/drop filter, wherein said filter drops and adds a fixed set of wavelengths at the node, wherein the fixed set includes wavelengths from different bands, while forwarding wavelengths that do not comprise the fixed set through the node.

31. The optical node according to claim 30, wherein the fixed set of wavelengths is predetermined prior to installation of the filter in the network.

32. The optical node of claim 31, wherein the fixed set of wavelengths is independent of a level of traffic at the node.

33. The optical node of claim 31, wherein the fixed set initially includes wavelengths that do not carry information, in order to reserve the wavelengths that do not carry information for future growth of the network.

34. The optical node of claim 33, wherein the node includes:
a plurality of thin-film filters for removing the fixed set of wavelengths from the network; and
a receiver for converting the fixed set of wavelengths to electrical signals.

35. The node of claim 30, wherein the fixed set comprises one wavelength from each band in the network.

36. The node of claim 30, wherein the fixed set comprises two wavelengths from a first band, and two wavelengths from a second band.

37. The node of claim 30, wherein the fixed set comprises a first wavelength from a first band, and a plurality of wavelengths from a second band.

38. The node of claim 30, wherein the fixed set comprises multiple wavelengths from a plurality of bands.

39. A method of adding wavelengths to a multi-wavelength optical signal in an optical communications network, said network comprising a plurality of nodes connected by an optical transmission medium carrying a plurality of wavelengths divided into discrete bands, wherein each band constitutes a group of contiguous wavelengths, said method comprising:
determining a fixed set of wavelengths to be added at an intermediate node in the network, wherein the fixed set includes wavelengths from a plurality bands in the multi-wavelength optical signal; and
deploying a filter to add the fixed set to the multi-wavelength optical signal.

40. The method of claim 39, wherein the step of determining the fixed set includes partitioning each band into a first subset of wavelengths to be added at a particular node and a second subset of wavelengths that is not added to the multi-wavelength optical signal at the node.

41. The method of claim 40, wherein the step of partitioning includes selecting one wavelength from each band in the multi-wavelength optical signal to be included in the first subset.

42. The method of claim 40, wherein the step of partitioning includes selecting two wavelengths from a first band and two wavelengths from a second band to be included in the first subset.

43. The method of claim 40, wherein the step of partitioning includes selecting one wavelength from a first band, and a plurality of wavelengths from a second band to be included in the first subset.

44. The method of claim 40, wherein the step of partitioning includes selecting multiple wavelengths from a plurality of bands to be included in the first subset.

45. A method of adding and dropping wavelengths from a multi-wavelength optical signal in an optical communications network, said network comprising a plurality of nodes connected by an optical transmission medium carrying a plurality of wavelengths divided into discrete bands, wherein each band constitutes a group of contiguous wavelengths, said method comprising:
determining a fixed set of wavelengths to be added and dropped at an intermediate node in the network, wherein the fixed set includes wavelengths from a plurality bands in the multi-wavelength optical signal;
deploying a filter to add and drop the fixed set; and
forwarding wavelengths in the optical signal that do not comprise the fixed set.

46. The method of claim 45, wherein the step of determining the fixed set includes partitioning each band into a first subset of wavelengths to be added/dropped at a particular node and a second subset of wavelengths to pass through the node unaffected.

47. The method of claim 46, wherein the step of determining the fixed set further includes selecting individual filter components that correspond to each wavelength in the fixed set.

48. The method of claim 46, wherein the step of partitioning includes selecting one wavelength from each band in the multi-wavelength optical signal to be included in the first subset.

49. The method of claim 46, wherein the step of partitioning includes selecting two wavelengths from a first band and two wavelengths from a second band to be included in the first subset.

50. The method of claim 46, wherein the step of partitioning includes selecting one wavelength from a first band, and a plurality of wavelengths from a second band to be included in the first subset.

51. The method of claim 46, wherein the step of partitioning includes selecting multiple wavelengths from a plurality of bands to be included in the first subset.
